(19) United States
(12) Patent Application Publication
(10) Pub. No.: US 2011/0278040 A1
(43) Pub. Date: Nov. 17, 2011

(54) ELASTIC CONDUCTOR

(75) Inventors: Yingying Zhang, Los Alamos, NM (US); Quanxi Jia, Los Alamos, NM (US)

(73) Assignee: LOS ALAMOS NATIONAL SECURITY, LLC, Los Alamos, NM (US)

(21) Appl. No.: 12/779,588

(22) Filed: May 13, 2010

(51) Int. Cl. H01B 7/06; B32B 38/00; B32B 37/02; B32B 37/24

(52) U.S. Cl. 174/69; 156/242; 156/229; 977/742

(57) ABSTRACT

Elastic conductors made of ribbons of aligned carbon nanotubes embedded in a matrix of poly(dimethylsiloxane) exhibit a stabilized resistance after several cycles of stretching and releasing. The elastic conductors were prepared by drawing a ribbon of carbon nanotubes from an aligned array of carbon nanotubes and positioning on cured poly(dimethylsiloxane). After providing each end of the ribbon with an electrode, a film of uncured poly(dimethylsiloxane) was cast on the ribbon and electrodes. After curing the film an elastic conductor was produced. The electrical resistance of this elastic conductor became stable after a few cycles of stretching and releasing to strains up to 100%.

### STATEMENT REGARDING FEDERAL RIGHTS

This invention was made with government support under Contract No. DE-AC52-06NA25396 awarded by the U.S. Department of Energy. The government has certain rights in the invention.

### FIELD OF THE INVENTION

The present invention relates generally to elastic electronics and more particularly to an elastic conductor that includes a ribbon of aligned carbon nanotubes in a matrix of elastic polymer.

### BACKGROUND OF THE INVENTION

Elastic electronics is emerging as one of the most interesting research topics in materials science and technology [1, 2]. Elastic conductors are stretchable, foldable, and deformable into complex curvilinear shapes. Their elastic properties may make new applications possible that would be otherwise impossible with more conventional rigid electronics. Examples of such applications include flexible displays, electronic eyeball cameras, stretchable electronic implants, and conformable skin sensors [3-6].

A major challenge in elastic electronics relates to the development of electronic wiring that is both elastic and conductive. Elastic conductors have been prepared by fabricating wavy or net-shaped conductive structures by releasing pre-strained elastic substrates with conductive materials in the structures [7]. Metal-coated net films, wavy one-dimensional metal ribbons, and two-dimensional metal membranes have been prepared based on this strategy [8-11]. An alternative strategy utilizes conductive materials with large aspect ratio or in a liquid state [12, 13]; these materials can bridge cracked regions to maintain their conductive properties under tensile strains.

Films of carbon nanotubes (CNTs) [14] have been used for making flexible and transparent electrodes [15-18].

Elastic conductors of black composite films of CNT/ionic liquid/fluorinated copolymers have been prepared. Their conductivity deteriorates when they are stretched [2].

Transparent CNT films with randomly distributed CNTs have been reported as elastic conductors. Although these films remained conductive under linear strains up to 700%, their conductivity decreases superlinearly with strains [19].

### SUMMARY OF THE INVENTION

The present invention provides an elastic conductor that includes a matrix of poly(dimethylsiloxane) and a ribbon of substantially aligned carbon nanotubes. The ribbon has a first end and a second end. The elastic conductor includes a first electrode at the first end of the ribbon, and a second electrode at the second end of the ribbon. The ribbon and the electrodes are embedded in the matrix of poly(dimethylsiloxane).

The invention also provides a method for preparing an elastic conductor. The method involves drawing a ribbon of aligned carbon nanotubes from an aligned, supported array of carbon nanotubes. The ribbon of aligned carbon nanotubes is positioned on cured poly(dimethylsiloxane). An electrode is provided at each of the two ends of the ribbon. A film of uncured poly(dimethylsiloxane) is cast on the ribbon, electrodes, and cured poly(dimethylsiloxane). The alignment of the nanotubes is maintained during the casting. Afterward, the film is cured to produce the elastic conductor.

### BRIEF DESCRIPTION OF THE DRAWINGS

FIG. 1a shows a scanning electron micrograph of a supported array of aligned carbon nanotubes; FIGS. 1b and 1c show ribbons drawn from the array; FIG. 1d shows a transmission electron micrograph (TEM) of ribbons of carbon nanotubes on TEM grids; and FIG. 1e shows a TEM image of a ribbon; and the inset of FIG. 1e shows an image of an individual carbon nanotube.

FIG. 2a provides a schematic illustration of an embodiment process of embedding CNT ribbons in poly(dimethylsiloxane). Before encapsulating the carbon nanotubes, electrodes were connected to the two ends of each ribbon so that the conductivity can be measured. FIG. 2b shows optical images of an embodiment film that illustrate its transparency, and FIG. 2b shows an image of an embodiment film in a folded position.

FIG. 3a shows images an embodiment film being stretched; the top image shows the film prior to stretching, the middle image shows the film subjected to a tensile strain of 50%, and the bottom image shows the film subjected to a tensile strain of 100%. FIG. 3b shows graphs of resistance (in units of ohms) versus strain for the first stretching, the first releasing, and the second stretching. FIG. 3c shows a graph of resistance versus strain for the 6^{th} stretching and the 30^{th} stretching.

FIG. 4a shows a graph of the temperature dependence of the resistivity and conductivity of CNT ribbons measured by four probe method; and FIG. 4b shows a plot and linear fitting of ln σ versus T^{1/4}.

### DETAILED DESCRIPTION

The invention provides an elastic conductor that maintains a stable conductivity under repetitive stretching. The elastic conductor includes well-aligned CNT ribbons embedded in poly(dimethylsiloxane) (PDMS). The elastic conductor also includes an electrode at each end of the ribbon. The electrodes were partially embedded in PDMS.

It is already known in the art of CNTs and CNT ribbons that Jiang et al. reported drawing ribbons of CNTs from a supported array of aligned CNTs [20]. Since then, a variety of applications for CNT ribbons have been reported [21-23]. CNT ribbons represent a CNT assembly in which aligned CNTs form bundles with neighbor CNTs along their axial direction [24]. These CNT ribbons have been prepared with lengths up to several meters.

The conductivity of the elastic conductor of this invention remains stable under linear tensile strain after the first several cycles of stretching/releasing under tensile strain up to 100%. By contrast, CNT films of the prior art have been reported to show a large decrease in their conductivity under strain [2, 19].

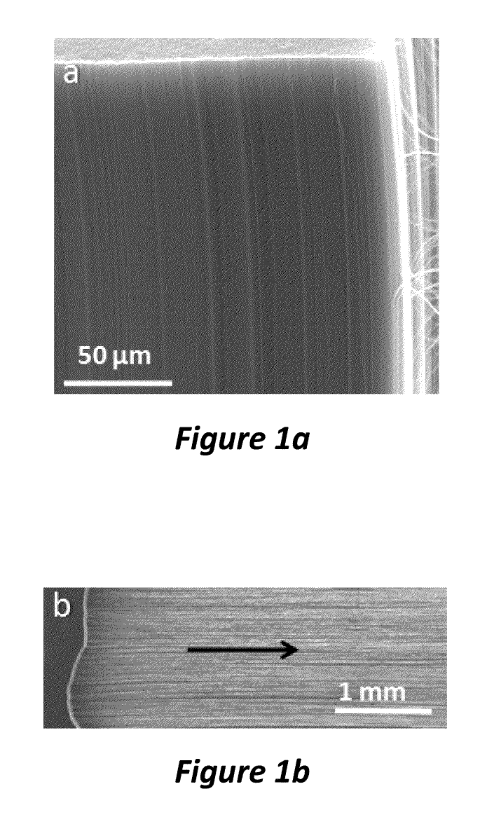

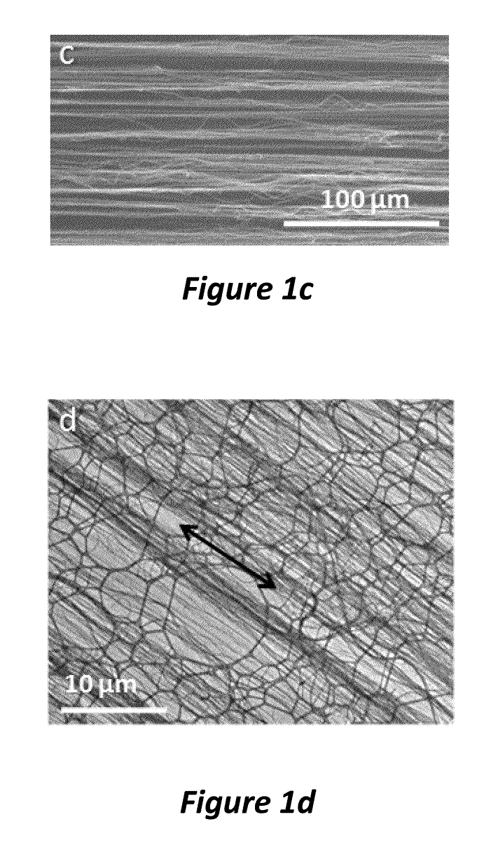

The CNT ribbons used in the present invention were drawn from supported arrays of aligned multi-walled carbon nanotubes. FIG. 1a shows a side view of a scanning electron microscope (SEM) image of an array. The CNTs in the array appear to be straight, parallel to each other, continuous from the bottom to the top of the array, and have heights of around 0.6 millimeters (mm). This kind of aligned CNT array enables the drawing of continuous CNT ribbons [24]. Edges of the array where CNT ribbons are drawn out are shown at the right side of FIG. 1a and at the left side of FIG. 1b, which shows a top view of the CNT ribbons drawn from the CNT array. The ribbons are uniform and aligned along the drawing direction (shown by the arrow).

FIG. 1d shows a transition electron microscope (TEM) image of the CNT ribbons. In this image, aligned CNTs dominate the structure. A TEM image is also shown in FIG. 1c, from which one can see CNT bundles and interconnections between the bundles. The formation of CNT bundles is important in being able to draw continuous ribbons from a CNT forest. The inset of FIG. 1c shows a typical high-resolution TEM image of individual CNTs. The CNTs have an average diameter around 10 nanometers (nm). Most of the nanotubes have 4, 5, or six walls.

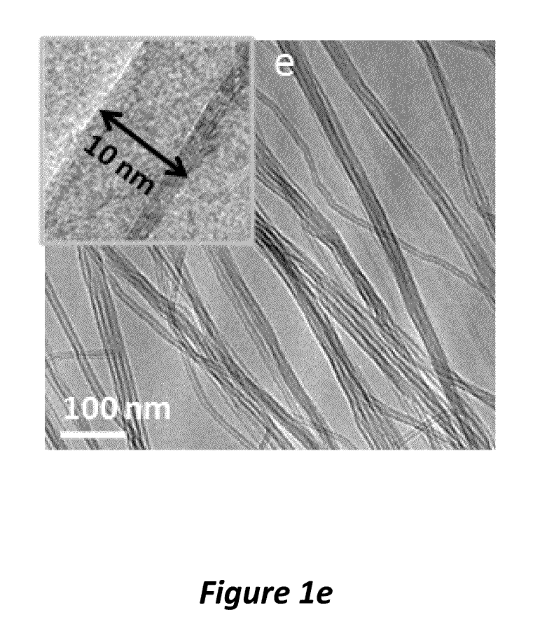

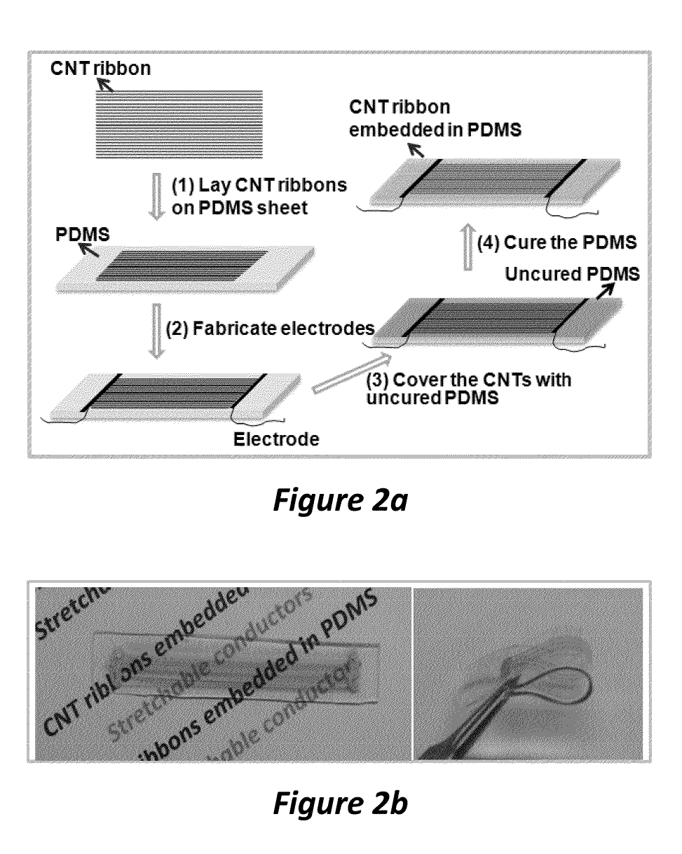

FIG. 2a illustrates the steps to fabricate elastic CNT/PDMS films. First, the CNT ribbons directly drawn out from CNT array were positioned on the surface of a flat PDMS film. Electrodes at the two ends of the CNT ribbons were then prepared for an electrical conductivity measurement. Following that, a thin layer of uncured PDMS was cast onto the CNT/PDMS. The interaction between CNTs and PDMS was so strong that the CNTs did not move once they came into contact with the surface of the PDMS film. Finally, the whole sample was heated in an oven at 100° C. for 1 hour to cure the uncured PDMS. FIG. 2d shows an image of the product CNT/PDMS film after the curing. The product film is transparent and flexible.

The transparency of the embodiment elastic conductor of this invention varies with the thickness of PDMS and the CNT ribbons. For the film shown in FIG. 2b, a transparency of approximately 60% in wavelengths ranging from 400 nm to 800 nm was measured by UV-Vis spectroscopy. The films can be twisted or folded, showing excellent flexibility and robustness.

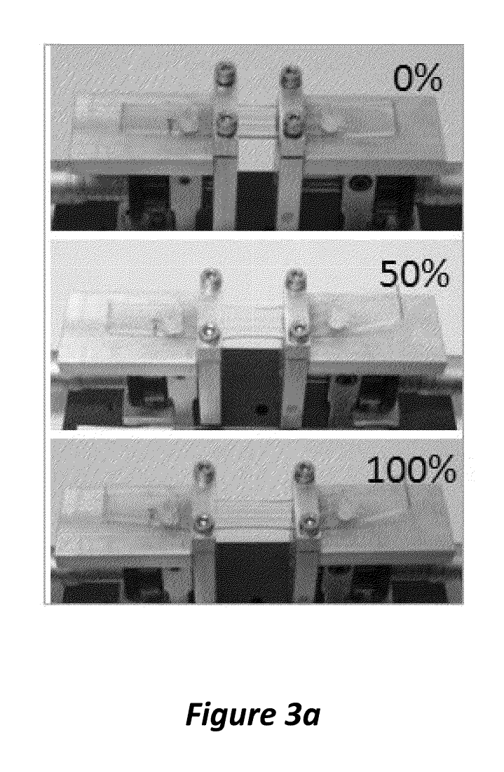

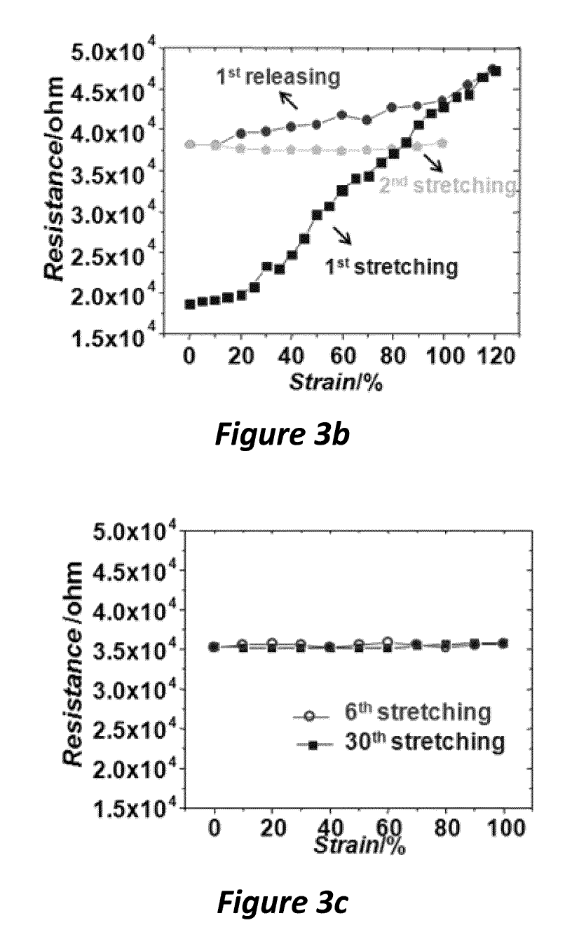

The current-voltage (I-V) characteristics of the embodiment elastic conductors of this invention were measured under various tensile strains. A mechanical stretching system with precise length control was used to apply tensile stress. The electrode contact areas were left untouched while the central area with a length of 1 centimeter (cm) was stretched (see FIG. 3a) during the measurement. I-V curves were recorded right after different strains were applied. The measured I-V curves showed a linear dependence, indicating good ohmic contacts between the CNT ribbons and the electrodes. In the first cycle of stretching, the resistance of CNT/PDMS film increased moderately with increasing tensile strain. The film remained conductive under a tensile strain of up to 150%. The resistance as a function of tensile strain in the first stretching cycle is shown in FIG. 3b (with square symbol). When the film was stretched to 220% of (or 120% longer than) its original length, the resistance increased from 18.8 kΩ to 47.3 kΩ (increased by 1.5 times).

The resistance of CNT ribbons is due to (1) resistance of individual CNTs and (2) the contact resistance between CNTs. The resistivity of individual CNTs is generally two orders of magnitude lower than the resistivity of their assemblies [25]. Therefore, the contact resistance between CNTs dominates the conduction behavior of CNT ribbons. While CNT ribbons are stretched, the alignment of the CNTs improves along the tensile direction. Stretching also leads to less local interconnections or decreased contact area between neighboring CNTs [26]. As the contact area between neighboring CNTs decreases, the total contact resistance increases. As a result, the total resistance of CNT ribbons will increase under tensile strain.

To investigate the reversibility of this conductor, repetitive stretching/releasing cycles were applied to the embodiment elastic conductor. I-V curves were recorded during the cycles. In the first cycle of releasing from 120% to 0% tensile strain, the conductivity of a CNT/PDMS film was partially recovered (FIG. 3b, with round symbols). The resistance decreased from 47.3 kΩ under 120% tensile strain to 38 kΩ when the film was fully released. It is believed that the decrease in resistance is due, at least in part, to a partial reconnection of CNTs as the film releases. Following the first cycle, we performed the second round of stretching (up to strain of 100%). The change in resistance in the second stretching cycle was much smaller that that in the first stretching cycle (FIG. 3b, with dark round symbol). The resistance under the tensile strain was smaller the second time compared to first stretching (43.4 kΩ in 1^{st} round vs. 38.2 kΩ in the 2^{nd} round with 100% tensile strain). When the film was released for the second time, the resistance decreased slightly again (not shown in FIG. 3b), which it is believed suggests that more local connections between CNTs were recovered. Additional stretching/releasing cycles were performed. The resistance decreased slightly in each releasing cycle. By the sixth round of releasing, there was no measurable change in the resistance of the film. Thus, a stable resistance was achieved after just a few stretching/releasing cycles. The measured resistances obtained after the sixth and thirtieth stretching cycles are shown in FIG. 3c. The resistances under tensile strain in the range of 0% through 100% remained nearly stable, having an average value of 35.5±0.3 kΩ (standard deviation of 0.8%).

Ten embodiment elastic conductors of this invention were prepared and tested in the same way as described above. Similar resistance variation behaviors for observed for all ten as they were subjected to cycles of stretching/releasing. To the best of our knowledge, these are the first examples of an elastic conductor with a stable resistance under tensile strength up to 100%. By comparison, when a prior art elastic conductor that included randomly distributed CNTs, the resistance increased by approximately 50-fold. Similarly, for another prior art elastic conductor of CNT and fluorinated copolymer, the resistance increase by approximately 10-fold under a tensile stain of 100% [2]. By contrast, an elastic conductor of this invention which includes aligned CNT ribbons embedded in poly(dimethylsiloxane) has been shown to have a stable resistance after a mere few initial cycles of stretching/releasing.

Some differences between the CNTs used in this invention and those reported in two studies ([2] and [19]) can be summarized as follows: (1) in this invention, multi-walled CNTs are used; in the prior studies, single-walled CNTs were used; (2) in this invention, a macroscopically aligned ribbon of CNTs was used; in the prior studies, randomly dispersed CNTs were used; and (3) in this invention, the CNTs are not subjected to post-synthetic grinding and/or sonication.

It is believed that alignment of the CNTs plays a significant role in stabilizing the resistance of the elastic conductors of this invention when they are subjected to strain.

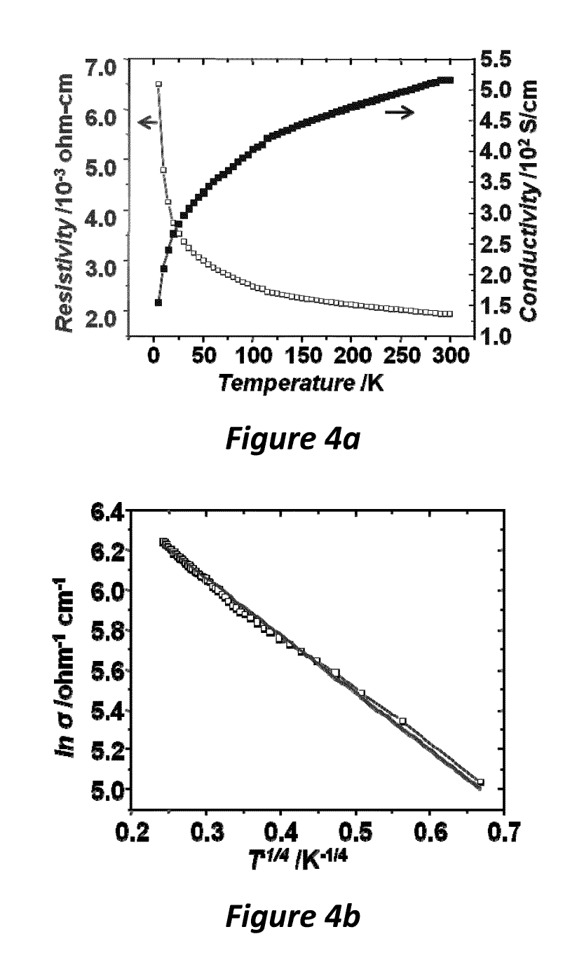

To better understand the behavior of the elastic conductors of this invention, the temperature dependent conductivity of CNT ribbons was explored. FIG. 4a shows the temperature dependence of the resistivity and conductivity of a CNT ribbon measured by a standard four probe method in a temperature range of 5K to 300K. The resistivity decreases monotonically from 6.5×10⁻³ Ω-cm at 5K to 1.9×10⁻³ Ω-cm at 300K, indicating a semiconducting behavior. Two mechanisms have been suggested to explain the temperature dependence of conductivity: variable range hopping (VRH) [27] and tunneling conduction mechanism [28]. They can be described by the following two equations, respectively:

σ=σ₀exp(−A/T^{1/4}), and σ=σ₀exp(−B/T^{1/2})

where σ is the conductivity, σ₀, A, and B are constants, and T is temperature. FIG. 4b, which is a plot of ln σ versus T^{1/4} based on the first of the two equations above, shows a much higher linearity than that of ln σ versus T^{1/2} based on the second of the two equations above, indicating that the conduction of CNT ribbons is mainly controlled by Mott's VRH mechanism [29], which can be expressed as a σ=σ₀ exp(−A/T^{1/(d+1)}) where A is a constant and “d” is the hopping space dimensionality [29]. The plots of ln σ versus T^{1/(d+1)} for d=1, 2, and 3 suggests a three-dimensional (3D) VRH mechanism. This may be due to the CNT ribbons being composed of a network of dispersed bundle-bundle connections, as seen in FIG. 1e, where the contacts between the CNT bundles act as conduction paths for the carriers to transport in the system.

The mechanism for the resistance variation behaviors of the elastic conductors of this invention under stretching/releasing is not completely understood. A rearrangement of CNTs in ribbons induced by the stretching/releasing may be responsible for the above phenomenon. As described earlier, CNT ribbons possess a network structure of CNT bundles, where individual CNTs are aligned in one direction on the macroscopic scale but are partly wavy in the microscopic scale. The CNTs are mechanically very strong along the axial direction [30], much stronger than the van der Walls force between the CNTs. This suggests tensile and compression strain will mainly affect the network between CNTs while individual CNTs maintain their intrinsic structures. With the application of tensile strains, CNTs can slide against each other along the tensile direction. For the first stretching process, two main structural changes can happen: (1) the connection between CNTs becomes weak or even locally detached; and (2) wavy CNTs will be straightened under the tensile strain, which leads to a higher degree of alignment. The weakening and detachment of the connection results in a smaller overall contact area between CNTs, providing an increased resistance. When the film is being released, a strain in the reverse direction is applied on CNTs. This strain enables the rearrangement of CNTs in the network. Localized bending and rotation will happen along CNTs [31-33] leading to formation of uniform wavy structures along CNTs and better connections between CNTs. Improved connections contribute to the decreased resistance in the releasing process. When the film is stretched again, its main change can be the straightening of wavy structures, which does not affect the overall resistance. By analogy, repetitive releasing will further improve the CNT arrangement in ribbons until a balance is achieved. A few stretching/releasing cycles leads to a stabilized microstructure, which enables the CNT ribbons working as a stretchable conductor with stable resistance under strain with additional cycles of stretching/releasing. Similar to the reported formation of wavy metal and semiconductor patterns [8, 9], CNT ribbons can also be put on a pre-stretched PDMS film, leading to the formation of periodic wavy CNTs after releasing the PDMS. We prepared such a sample on a 50% pre-stretched PDMS film. In this case, the sample resistance does not change under strains in the range of 0-50%, but shows the similar behaviors as the samples prepared on relaxed PDMS when the strains exceed 50%.

The present invention is more particularly described in the following example which is intended as illustrative only, because numerous modifications and variations will be apparent to those skilled in the art.

### EXAMPLE

A catalyst of: (1) a silicon dioxide substrate, (2) a 10 nanometer thick layer of aluminum oxide on the silicon dioxide substrate, and (3) a 1.0 thick layer of Fe on the aluminum oxide layer, was heated to 750° C. while exposed to a gas mixture of 140 sccm forming gas and 30 sccm of ethylene for 12 minutes. Optimized pretreatment conditions [24] were used. A supported array of aligned carbon nanotubes was produced.

Cured poly(dimethylsiloxane) (PDMS) (SYLGARD 184, DOW CORNING) film was prepared by mixing PDMS gel with a cross linker in a 10:1 weight ratio, pouring the mixture onto a glass slide, and curing by heating at 100° C. for 1 hour.

Ribbons of aligned carbon nanotubes were drawn directly out of the CNT array. The ribbons were positioned on the PDMS film.

Electrodes were fabricated by applying silver paint at the ends of the CNT ribbons. A thin layer of uncured PDMS (SYLGARD 184, Part A/Part B=10:1) was then coated on the top of the CNT ribbon. The whole sample was heated at 100° C. to cure the thin layer.

Scanning electron microscopy (SEM) and transmission electron microscopy (TEM) were used to characterize the CNTs. The TEM sample was prepared by laying the as-drawn CNT ribbon on a TEM grid and stabilizing the ends of the ribbon with silver paint. A precise length-controlling system was used to apply tensile strain when current-voltage (I-V) curves were measured using a KEITHLEY 487 picoammeter/voltage source. The temperature dependent conductivity was measured by a four probe method using a physical property measurement system (PPMS) in the temperature range of 5K through 300K.

In summary, elastic conductors of CNT ribbons embedded in PDMS were prepared. The elastic conductors were subjected to cycles of stretching and releasing. Their resistance to strain stabilized after several stretching/releasing cycles, and a stable microstructure was achieved. The elastic conductors exhibited a temperature dependent conductivity measurement consistent with a 3D hopping mechanism. The elastic conductors show good transparency, excellent flexibility, and stable resistance with application of strains up to 100%. The maximum strain value is limited by the stretchability of PDMS for the CNT/PDMS film. Although the invention was demonstrated using PDMS as the elastic polymer, larger strains are expected if a material with better elasticity is used. The resistance and the transparency of the elastic conductors of this invention may be controlled by varying the height and number of walls of the CNTs, the number of layers of CNT ribbons (more layers, more conductive but less transparent), and the matrix polymers. To the best of our knowledge, this is the first elastic conductor with CNTs that is an elastic conductor with a stable resistance under strain.

### REFERENCES

The following references are incorporated by reference herein.
[1] Rogers et al., “A Curvy Stretchy Future for Electronics,” Proc. Natl. Acad. Sci. USA, July 2009, vol. 106, pp. 10875-10876.
[2] Sekitani et al., “A Rubberlike Stretchable Active Matrix Using Elastic Conductors,” Science, September 2008, vol. 321, pp. 1468-1472.
[3] Sekitani et al., “Stretchable Active-Matrix Organic Light-Emitting Diode Display Using Printable Elastic Conductors,” Nature Materials, June 2009, vol. 8, pp. 494-499.
[4] Kim et al., “Ultrathin Silicon Circuits With Strain-Isolation Layers and Mesh Layouts for High-Performance Electronics on Fabric, Vinyl, Leather, and Paper,” Advanced Materials, July 2009, vol. 21, pp. 3703-3707.
[5] Yuan et al., “Fault-Tolerant Dielectric Elastomer Actuators Using Single-Walled Carbon Nanotube Electrodes,” Advanced Materials, January 2008, vol. 20, pp. 621-625.
[6] Someya et al., “Conformable, flexible, large-area networks of pressure and thermal sensors with organic transistor active matrixes,” Proc. Nat'l. Acad. Sci. USA, August 2005, vol. 102, pp. 12321-12325.
[7] Bowden et al., “Spontaneous Formation of Ordered Structures in Thin Films of Metals Supported on an Elastic Polymer,” Nature, May 1998, vol. 393, pp. 146-149.
[8] Sun et al., “Buckled and Wavy Ribbons of GaAs for High-Performance Electronics on Elastomeric Substrates,” Advanced Materials, November 2006, vol. 18, pp. 2857-2862.
[9] Song et al., “Mechanics of Stretchable Inorganic Materials,” J. Vac., Sci. Technol. A, July 2009, vol. 27, pp. 1107-1125.
[10] Lacour et al., “Stretchable Gold Conductors on Elastomeric Substrates,” Appl. Phys. Lett., April 2003, vol. 82, pp. 2404-2406.
[11] Kim et al., “Bend, Buckle, and Fold: Mechanical Engineering with Nanomembranes,” ACS Nano, March 2009, vol. 3, pp. 498-501.
[12] Cheng et al., “Liquid metal stretchable unbalanced loop antenna,” Appl. Phys. Lett., April 2009, vol. 94, pp. 144103 through 144103-3.
[13] Kim et al., “A multiaxial stretchable interconnect using liquid-alloy-filled elastomeric microchannels,” Appl. Phys. Lett., January 2008, vol. 92, pp. 011904 through 011904-3.
[14] Thostenson et al., “Advances in the Science and Technology of Carbon Nanotubes and their Composites: a Review,” Compos. Sci. Technol., October 2001, vol. 61, pp. 1899-1912.
[15] Wu et al., “Transparent, Conductive Carbon Nanotube Films,” Science, August 2004, vol. 27, pp. 1273-1276.
[16] Zhang et al., “Transparent, Conductive, and Flexible Carbon Nanotube Films and Their Applications in Organic Light-Emitting Diodes,” Nano Lett. September 2006, vol. 6, pp. 1880-1886.
[17] Gu et al., “Fabrication of Free-standing, Conductive, and Transparent Carbon Nanotube Films,” Advanced Materials, December 2008, vol. 20, pp. 4433-4437.
[18] Tenent et al., Ultrasmooth, Large-Area, High-Uniformity, Conductive Transparent Single-Walled-Carbon-Nanotube Films for Photovoltaics Produced by Ultrasonic Spraying,” Advanced Materials, August 2009, vol. 21, pp. 3210-3216.
[19] Hu et al., “Highly Stretchable, Conductive, and Transparent Nanotube Thin Films,” Applied Physics Letters, April 2009, vol. 94, pp. 161108-1 through 161108-3.
[20] Jiang et al., “Spinning Continuous Carbon Nanotube Yarns,” Nature, October 2002, vol. 419, pp. 801.
[21] Zhang et al., “Multifunctional Carbon Nanotube Yarns by Downsizing an Ancient Technology,” Science, November 2004, vol. 306, pp. 1358-1361.
[22] Xiao et al., “Flexible, Stretchable, Transparent Carbon Nanotube Thin Film Loudspeakers,” Nano Letters, December 2008, vol. 8, pp. 4539-4545.
[23] Zhang et al., “Cross-Stacked Carbon Nanotube Sheets Uniformly Loaded with SnO₂ Nanoparticles: A Novel Binder-Free and High-Capacity Anode Material for Lithium-Ion Batteries,” Advanced Materials, June 2009, vol. 21, pp. 2299-2304.
[24] Zhang et al., “Tailoring the Morphology of Carbon Nanotube Arrays: From Spinnable Forests to Undulating Foams,” ACS Nano, August 2009, vol, 3, pp. 2157-2162.
[25] Li et al., “Structure-Dependent Electrical Properties of Carbon Nanotube Fibers,” Advanced Materials, October 2007, vol, 19, pp. 3358-3363.
[26] Zhang et al., “Ultrastrong, Stiff, and Lightweight Carbon Nanotube Fibers,” Advanced Materials, December 2007, vol. 19, pp. 4198-4201.
[27] Mott, “Conduction in Non-crystalline Materials III. Localized States in a Pseudogap and Near Extremities of Conduction and Valence Bands,” Philosophical Magazine, 1969, vol. 19, pp. 835-852.
[28] Ma et al., “Electron Transport Properties in CoAlO Composite Antidot Arrays,” Europhysics Letters, November 2006, vol. 76, pp. 1144-1150.
[29] Aggarwal et al., “Variable-range hopping in Fe70Pt30 catalyzed multi-walled carbon nanotube film,” The European Physical Journal B, December 2007, vol. 60, pp. 319-324.
[30] Yu et al., “Strength and Breaking Mechanism of Multiwalled Carbon Nanotubes Under Tensile Load,” Science, January 2000, vol. 287, pp. 637-640.
[31] Lourie et al., “Buckling and Collapse of Embedded Carbon Nanotubes,” Physical Review Letters, August 1998, vol, 81, pp. 1638-1641.
[32] Lance et al., “Reorientation of Carbon Nanotubes in Polymer Matrix Composites Using Compressive Loading,” J. Mater. Res., April 2005, vol. 20, pp. 1026-1032.

What is claimed is:

1. An elastic conductor comprising:
a matrix of poly(dimethylsiloxane),
a ribbon of aligned carbon nanotubes embedded in said matrix of poly(dimethylsiloxane), the ribbon having a first end and a second end,
a first electrode at said first end of said ribbon, and
a second electrode at said second end of said ribbon.

2. The elastic conductor of claim 1, wherein said elastic conductor is subjected to cycles of stretching and relaxing until the elastic conductor has a stable electrical resistance.

3. A method for preparing an elastic conductor, comprising:
drawing a ribbon of aligned carbon nanotubes from a supported array of aligned carbon nanotubes,
positioning the ribbon of carbon nanotubes on cured poly(dimethylsiloxane), the ribbon having a first end and a second end,
forming a first electrode at the first end of the ribbon,
forming a second electrode at the second end of the ribbon,
casting a film of uncured poly(dimethylsiloxane) on the ribbon and cured poly(dimethylsiloxane) whereby alignment of the carbon nanotubes is maintained, and curing the film.

4. The method for preparing an elastic conductor of claim 5, further comprising a step after the step of curing the film of:
subjecting the elastic conductor to cycles of stretching and relaxing along an axial direction of the ribbon until the film comprises a stable electrical resistance.

5. The method for preparing an elastic conductor of claim 3, wherein the step of casting further comprises casting the film of uncured poly(dimethylsiloxane) on the first electrode and on the second electrode.
